(19) United States
(12) Patent Application Publication
(10) Pub. No.: US 2026/0199173 A1
(43) Pub. Date: Jul. 16, 2026

(54) EXERCISE DEVICE WITH A PRESSURE MEMBER

(71) Applicant: Nikola Vratonjic, Chicago, IL (US)

(72) Inventor: Nikola Vratonjic, Chicago, IL (US)

(21) Appl. No.: 19/019,124

(22) Filed: Jan. 13, 2025

(51) Int. Cl. A61H 7/00

(52) U.S. Cl. CPC A61H 7/001; A61H 2201/0192; A61H 2201/1261; A61H 2201/1652; A61H 2201/1695

(57) ABSTRACT

An exercise device is provided and includes a body having a plurality of sides and an upper surface and a bottom surface and a plurality of protruding members on one of the upper surface or the bottom surface, where the plurality of protruding members are spaced from each other, and each of the protruding members have a semi-spherical shape and is positioned on a longitudinal axis of the body.

### BACKGROUND

The present application relates generally to an exercise device, and more particularly, to an exercise band having a pressure member that is attached to different areas of a person's body to apply pressure to muscles or muscle groups to promote toning of muscle and muscle growth.

Various bands and straps are used in the fitness industry to promote muscle toning and growth. For example, resistance bands are made with an elastic material and typically include an end with a handle where a user fixes the non-handle end of the band in place and then pulls on the handle. These resistance bands provide elastic tension that a person's muscles work against to create movement in a desired direction, which mimics the resistance the person would get from lifting weights. The tension provided by the resistance bands enables a person to build strength in different muscles and muscle groups. The resistance bands are made with materials having different levels of elasticity to provide different amounts of resistance or tension.

In another example, pressure bands, also known as Blood Flow Restriction (BFR) bands, are attached to a body part, such as an arm or leg, and work by partially restricting venous blood flow from the muscles in the designated body part while allowing arterial blood to still enter, essentially creating a “dam” effect that forces the muscles to work harder to pump blood back to the heart, leading to increased muscle growth and fatigue even with lighter weights. This is achieved by applying moderate pressure to a body part with the band positioned above the working muscle group.

It is therefore desirable to provide an exercise device that promotes muscle toning and muscle growth.

### SUMMARY

The present exercise device has a band and a pressure member movably attached to the band, where the pressure member includes a planar body and a plurality of protruding members extending from a surface of the body. The band is attached to a body part or area of a person's body so that the pressure member, and more specifically, the protruding members engage.

In an embodiment, an exercise device is provided and includes a body having a plurality of sides and an upper surface and a bottom surface and a plurality of protruding members on one of the upper surface or the bottom surface, where the plurality of protruding members are spaced from each other, and each of the protruding members have a semi-spherical shape and is positioned on a longitudinal axis of the body.

In another embodiment, an exercise device is provided and includes a harness having a primary band and two shoulder bands, where first ends of each of the two shoulder bands is attached to a front surface of the primary band and opposing second ends of the two shoulder bands is attached to a rear surface of the primary band. At least one pocket is attached to the primary band, where the at least one pocket includes an open top end and a pressure member including a body, where the body has a plurality of sides and an upper surface and a bottom surface. The pressure member is inserted into the open top end of the at least one pocket and a plurality of protruding members on one of the upper surface or the bottom surface of the body. The plurality of protruding

members are spaced from each other, where each of the protruding members has a semi-spherical shape and is positioned on a longitudinal axis of the body.

### BRIEF DESCRIPTION OF THE DRAWINGS

FIG. 1 is a perspective view of an embodiment of the present exercise device.

FIG. 2 is a front perspective view of an embodiment of the pressure member associated with the exercise device of FIG. 1.

FIG. 3 is a side view of the pressure member of FIG. 2, where the opposing side is a mirror image of this view.

FIG. 4 is an end view of the pressure member of FIG. 2, where the opposing end view is a mirror image of this view.

FIG. 5 is a top view of the pressure member of FIG. 2.

FIG. 6 is a bottom view of the pressure member of FIG. 2.

FIG. 7 is a perspective view of another embodiment of the pressure member.

FIG. 8 is a side view of the pressure member of FIG. 7 where the side includes a slot.

FIG. 9 is a side view of the pressure member of FIG. 7 that is adjacent to the side shown in FIG. 8.

FIG. 10 is a top view of the pressure member of FIG. 7.

FIG. 11 is a bottom view of the pressure member of FIG. 7.

FIG. 12 is a perspective view of a further embodiment of the pressure member.

FIG. 13 is a side view of the pressure member of FIG. 12.

FIG. 14 is a top view of the pressure member of FIG. 12.

FIG. 15 is a bottom view of the pressure member of FIG. 12.

FIG. 16 is a front view of an embodiment of an upper body support.

FIG. 17 is a front view and a rear view of an article of clothing including a pressure member.

### DETAILED DESCRIPTION

The present exercise device includes a pressure member that applies pressure to different muscles or muscle groups on a person's body to promote muscle growth and toning of the muscles or muscle groups.

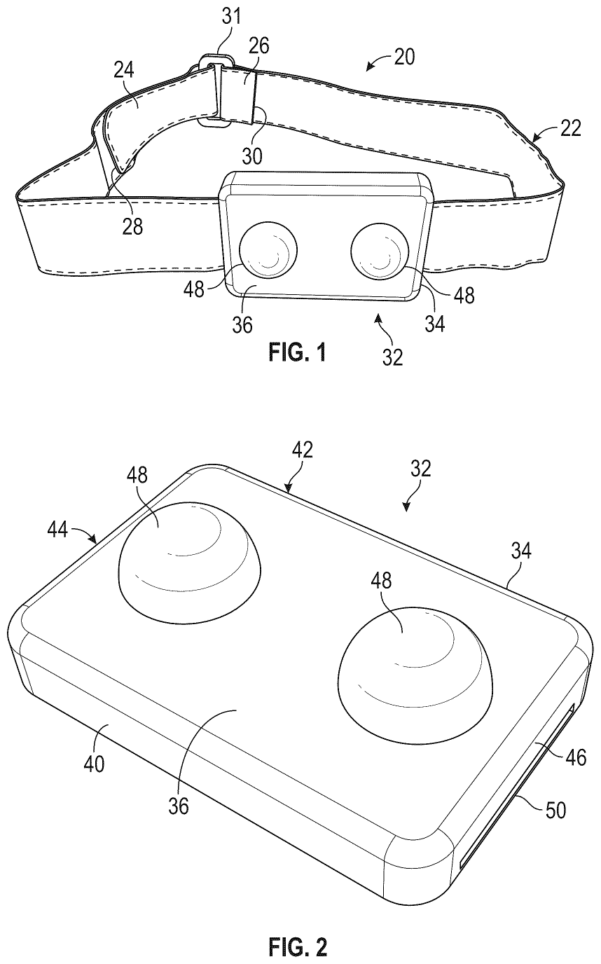

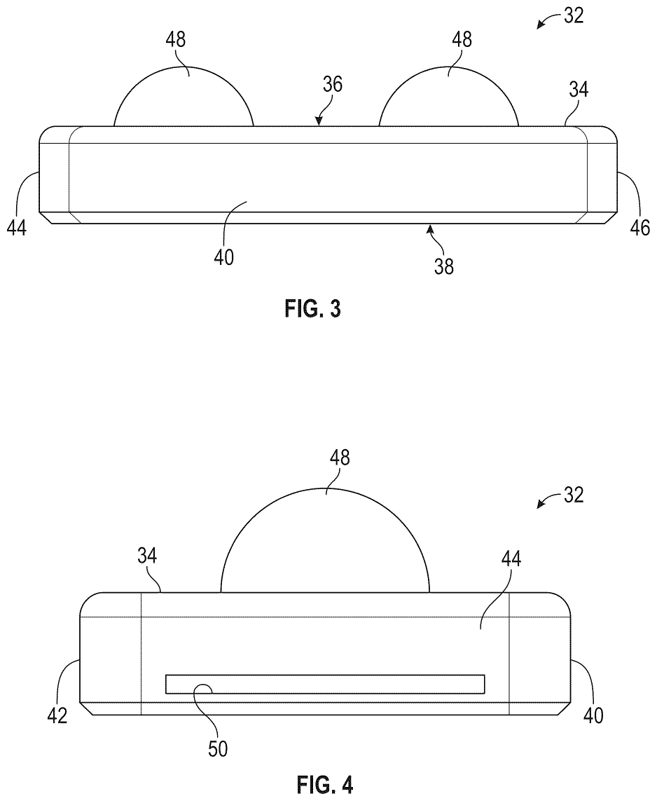

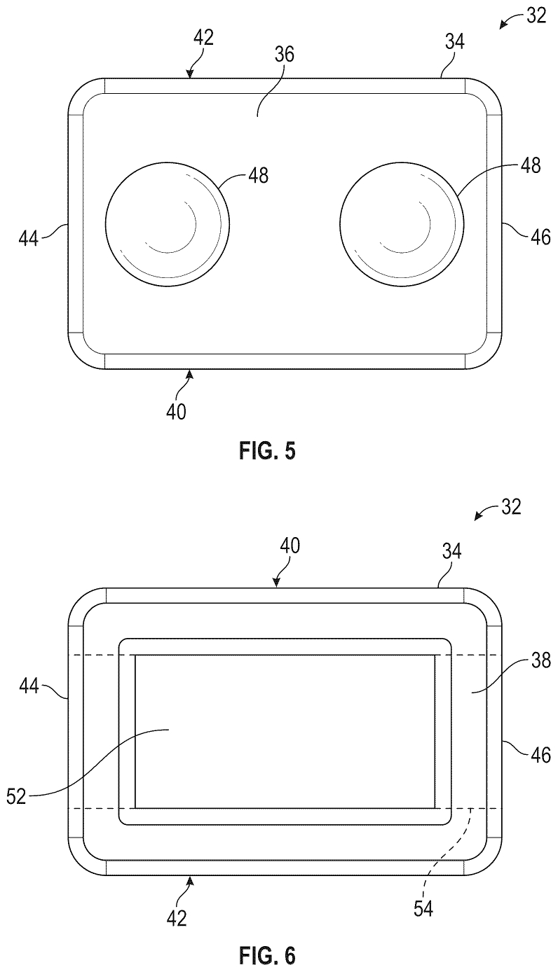

Referring now to FIGS. 1-6, an embodiment of the present exercise device is shown and generally indicated as 20, where the exercise device includes an attachment member, such as a strap or band 22. The band 22 has opposing ends 24 and 26, where a first end 24 of the band 22 includes a first attachment member 28 and a second end 26 that includes a second attachment member 30, where the first attachment member 28 and the second attachment member 30 each connect to an adjustment device 31 that enables the band to be adjusted to different lengths and to secure the band 22 to different areas or parts of a person's body, such as to an arm or leg. The adjustment device 31 may be any suitable adjustment device that enables the length of the band 22 to be adjusted. In the illustrated embodiment, the first attachment member 28 and the second attachment member 30 each include hooks and loops that are removably secured to each other. In another embodiment, the first attachment member 28 includes one or more prongs that are inserted into one or more corresponding receptacles in the second attachment member 30 to connect the first attachment member to the second attachment member similar to a buckle-type connection. In another embodiment, the first attachment member 28 and the second attachment member 30 are configured to slidably connect to each other and move relative to each other between a locked position and a released position. In a further embodiment, the band 22 does not include the first attachment member 28 and the second attachment member 30, where the band is stretched and positioned on the different areas or parts of a person's body. For example, the band is versatile may be attached to a muscle, muscles or a muscle group on a person's arms, chest, back, shoulders or legs.

A pressure member 32 is fixed to or movably attached to the band 22 and has a planar body 34 including an upper surface 36, a bottom surface 38, a first side 40, an opposing second side 42, a first end 44 and an opposing second end 46. The first side 40 and the second side 42 are each substantially transverse to the first and second ends 44 and 46, where the first and second sides 40 and 42 each have a first length and the first and second ends 44 and 46 each of a second length. In the illustrated embodiment, the first length is greater than the second length. It should be appreciated that the first length and the second length may the same or the second length may be greater than the first length. In an embodiment, the first length is 6.0 cm and the second length is 4.0 cm, where the first length and the second length may be any suitable lengths. Further, the body preferably has a thickness of 1.0 cm. It should be appreciated that the thickness of the body may be 0.5 cm to 2.0 cm, on any suitable thickness.

As shown in FIG. 2, the body 34 includes two semi-spherical protruding members 48 on the upper surface 36 of the body 34. In another embodiment, the protruding members 48 are on the bottom surface 38 of the body 34. In this embodiment, the protruding members 48 are spaced from each other on the longitudinal axis LA of the body 34. The protruding members 48 are also positioned at a designated distance from the first and second ends 44 and 46 of the body 34, where the distance is the same. In another embodiment, one or both protruding members 48 are not located on the longitudinal axis LA of the body 34 and are at the same or different distances from the first and second ends 44 and 46 of the body 34. It should be appreciated that the protruding members 48 may be positioned at any suitable locations on the upper surface 36 of the body 34. The protruding members 48 may have a semi-spherical shape as shown in FIG. 2, or a square shape, a rectangular shape, a triangular shape or any suitable shape. Further, the protruding members 48 may have the same shape as shown in FIG. 2 or different shapes. Also, the protruding members 48 may be the same size or different sizes.

Referring to FIGS. 4 and 6, the body 34 of the pressure member 32 includes a slot 50 formed in each end 44 and 46 of the body 34, where each slot communicates with a recessed area 52 formed in the bottom surface 38 of the body 34. The slots 50 and the recessed area 52 combine to form an elongated through channel 54 that is configured to receive one of the ends 24 or 26 of the band 22. Specifically, one of the ends 24 or 26 of the band 22 is inserted into one of the slots 50 on the body 34 and is moved through the recessed area 52 and then through the opposing slot 50 to attach the pressure member 32 to the band 22. The pressure member 32 may be moved along the band 22 to position the pressure member at any location along the band. In another embodiment, a plurality of the pressure members 32 are attached to the band 22 as described above, where the pressure members 32 may be the same or different from each other. For example, one pressure member 32 may have a rectangular shape and another pressure member 32 may have a square shape or a triangular shape.

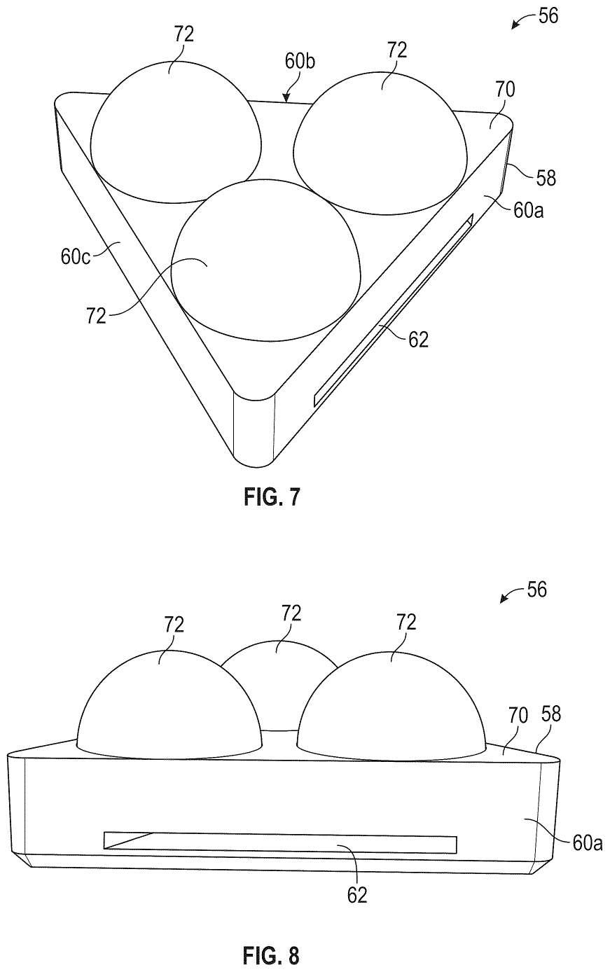

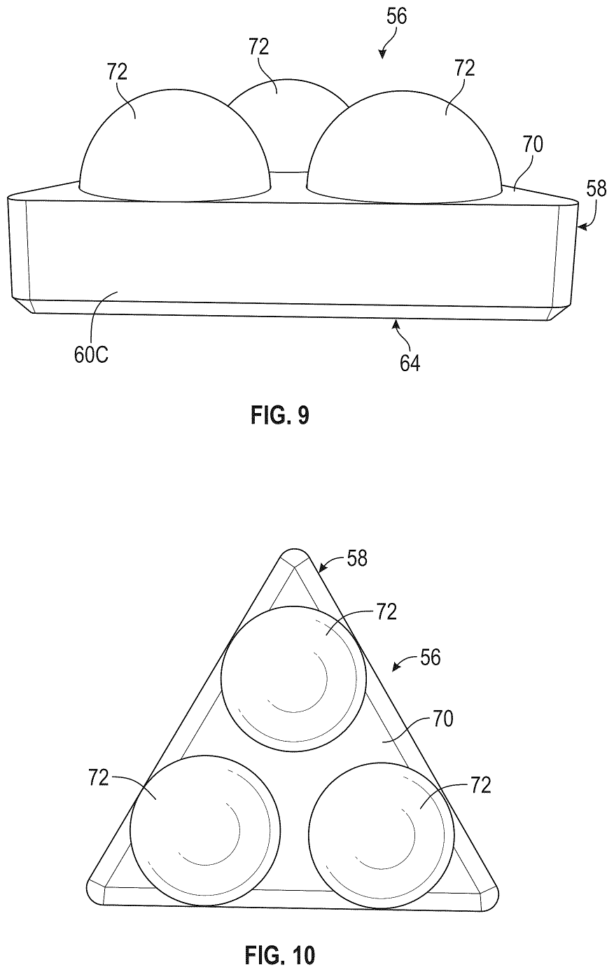

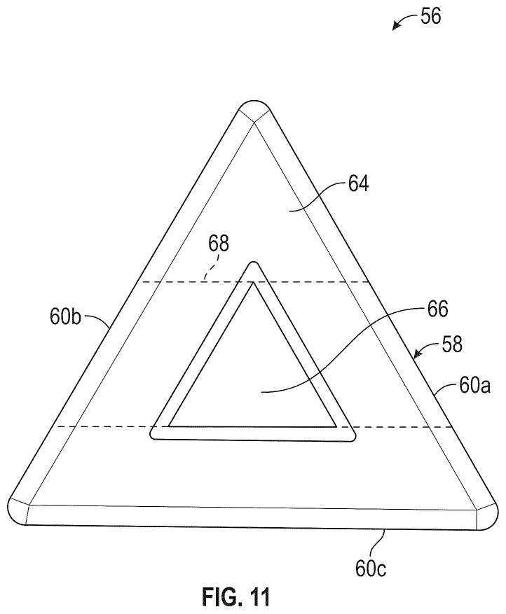

Referring now to FIGS. 7 to 11, another embodiment of the pressure member is shown where the pressure member 56 includes a body 58 having a triangular shape formed by three sides 60a, 60b and 60c. Each of the sides 60a, 60b and 60c each have a length and a height. In the illustrated embodiment, the length and the height of each of the sides 60a, 60b and 60c is the same. In another embodiment, the length and height of one or more of the sides 60a, 60b and 60c is different. As shown, two of the sides 60a and 60b have an opening or slot 62 where each slot 62 has a length and height that is greater than a width and thickness of the band 22 so that the band 22 may be inserted into and/or move through the slots 62. The back surface 64 of the body 58 has a recessed area 66 as shown in FIG. 11 where both of the slots 62 are in communication with the recessed area 66 such that the slots and the recessed area combine to form a through channel 68 extending from side 60a to side 60b. As described above, one end of the band 22 is inserted into one of the slots 62 and then the band 22 is moved through the through channel 68 and out through the opposing slot 62 to secure the pressure member 56 to the band 22.

The upper surface 70 of the body 58 includes three semi-spherical protruding members 72 that are spaced from each other and positioned between adjacent sides of the body 58. As shown, a portion of each of the protruding members contacts the edges of adjacent sides 60a, 60b and 60c of the body 58. In another embodiment, one or more of the protruding members 72 are spaced from the sides 60a, 60b and 60c of the body 58. Also, the protruding members 72 in this embodiment have the same size and shape. It should be appreciated that one or more of the protruding members 72 may have a different size and/or different shape. For example, all of the protruding members 72 may have a different size and/or a different shape.

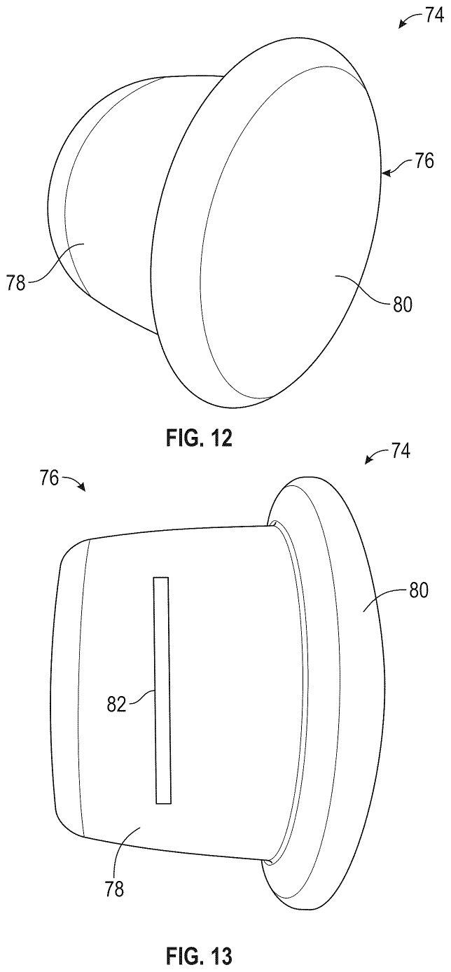

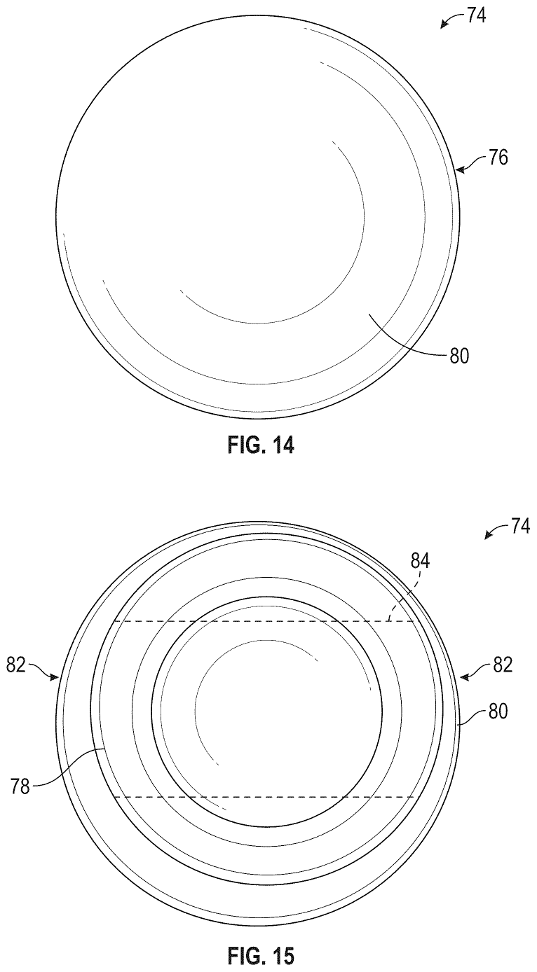

Referring to FIGS. 12 to 15, a further embodiment of the pressure member is shown, where the pressure member 74 has a body 76 with a cylindrical base 78 and a circular flange 80 extending outwardly from an end of the base 78. As shown, the flange 80 has a diameter that is greater than a diameter of the base 78. In another embodiment, the diameter of the flange 80 and the diameter of the base 78 are the same. In an embodiment, the base 80 includes two slots 82 and a through-hole 84 between the slots 82. In this embodiment, the band 22 is inserted through one of the slots 82 and through the through-hole 84 and out of the opposing slot 82 to attach the pressure member 74 to the band 22. The pressure member 74 is movable along the band 22 to different positions. Alternatively, the pressure member 74 is inserted into a pocket on a band or a pocket on a harness to position the pressure member 74 adjacent to a muscle or a muscle group on a person's body.

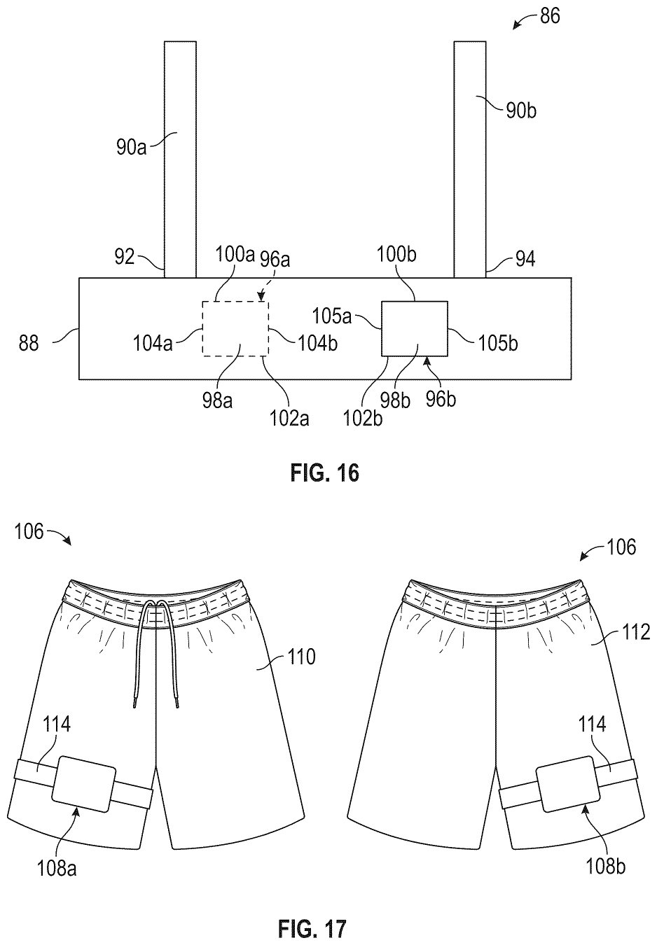

Referring to FIG. 16, in another embodiment, an upper body support such as harness 86 for holding a pressure member or a plurality of pressure members is provided and has a primary band 88 and two shoulder bands 90a and 90b. The shoulder bands 90a and 90b each have opposing ends 92 and 94 that are attached to the primary band 88 so that the shoulder bands 90a and 90b extend from a front side 96 of the primary band 88 to a rear side (not shown) of the primary band 88. The primary band 88 and the shoulder bands 90a and 90b each have an adjustment device (not shown) that enables a length of the primary band 88 and the shoulder bands 90a and 90b to be adjusted to fit over the upper body of a person. As shown in FIG. 16, the primary band 88 includes at least one pocket 96 that has a size and shape that is configured to receive a pressure member described above. In this embodiment, the primary band 88 includes a first pocket 96a that is attached to an inside surface of the primary band 88 and a second pocket 96b that is attached to an outside surface of the primary band 88. The first pocket 96a and the second pocket 96b each have a sleeve member 98a, 98b that has a top end 100a, 100b, a bottom end 102a, 102b and opposing sides 104a, 104b and 105a and 105b, where the sides and the bottom end are attached to the surface of the primary band 88 by stitching, adhesive and any suitable attachment method. The top end 100a, 100b has an opening for receiving a pressure member. The primary band 88 may have one or more pockets 96 where the pockets may be on any surface of the primary band. In use, a pressure member as described above, is inserted into the opening at the top end 100a, 100b of one of the pockets 96a, 96b, a plurality of the pockets or in each pocket on the primary band 88. In an embodiment, a flap (not shown) may be attached to a top end 100a, 100b of the sleeve member 98a, 98b and has a securing device, such as a snap or hooks and loops, for securing the flap to the sleeve to close the top end of the pocket. Alternatively, an inside surface of the sleeve member 98a, 98b may have a securing device to attach the top end of the sleeve to the surface of the primary band 88 to close the top end of the sleeve. Closing the top end of the pocket, helps to keep a pressure member inside the pocket during use.

Referring to FIG. 17, in another embodiment, an article of clothing, such as a shirt, pants or shorts 106 includes a pocket 108a and/or 108b for receiving a pressure member described above. The pocket 108a or 108b may be on the front surface 110 of the shorts 106 as shown in the left figure or on the rear surface 112 of the shorts as shown in right figure. The pocket 108a, 108b is configured as described above, where a band 114a, 114b is threaded through or attached to each pocket 108a, 108b and includes an adjustment device (not shown) that enables the band to be tightened or loosened relative to a person's leg. Tightening or loosening the band 114a, 114b moves a pressure member inside the pocket 108a, 108b closer to or further away from the person's leg to adjust the pressure of the pressure member on the persons'leg. It should be appreciated that the pocket 108a, 108b and band 114a, 114b may be attached to a shirt, shorts, pants, a jacket or any suitable article of clothing.

In the above embodiments, the body of the pressure member is made with a plastic material. It should be appreciated that the body of the pressure member may be made with a thermoplastic material, Polyvinyl chloride (PVC), Polyethylene terephthalate (PET), Polystyrene (PS), High-Density Polyethylene (HDPE), Low Density Polyethylene (LDPE), Polycarbonate (PC), Acrylonitrile butadiene styrene (ABS), a metal, rubber or any suitable material or combination of materials.

In use, in the above embodiments, the exercise device is attached to a designated body part by extending the band around the body part or by inserting the body part through a loop formed by the band. The exercise device is then moved along the body part until the pressure member is adjacent to a muscle or muscle group to be strengthened and/or toned by the exercise member. A user then adjusts the tension, i.e., the tightness or looseness, of the exercise device, and more particularly, the pressure member, relative to the muscle or muscle group to be strengthened by the exercise device. Next, the exercise member is secured in position as described above. When the user is finished exercising the target muscle or muscle group, the user loosens the tension on the band and removes the exercise device from the body part. It should be appreciated that a person may use one or more of the exercise devices on their body at the same time depending on the muscle or muscle groups that are being strengthened.

One of the most common ways to increase motor unit activation in a muscle, muscles or in a muscle group, is to lift heavier weights, because this activity increases the load placed on the muscle, muscles or muscle group, which causes a greater number of the motor units in the muscle, muscles or muscle group to activate more muscle fibers and generate the force necessary to overcome the resistance provided by a weight. Attachment of the exercise device to a body part or body parts while lifting weights helps to increase the load on the muscle, muscles or muscle group while using weights. In this regard, the pressure provided by the pressure member, and more specifically, the protruding members on the pressure member on the target muscle, muscles or muscle group translates into a better mind muscle connection as well as giving the muscle, muscles or muscle group the impression that it is working with more weight during an exercise.

During use, this exercise device works based on proprioception (perception or awareness of the position and movement of the body) with direct pressure applied by the protruding members to a target muscle and muscle group and the proprioceptors inside the muscle or muscle group. The exercise device also works on kinesthesia receptors, which are sensory receptors in the muscles, joints, and tendons that detect the movement and position of a person's body when a muscle or muscle group is active. Kinesthesia and proprioception are some of the most important aspects of improving the mind-muscle connection in a person's body. By positioning the exercise device in different areas of a persons'body, in different ways relative to the person's body parts and in different places on a target muscle and/or muscle group, the mind-muscle connection is optimized.

Proprioceptors and kinesthesia receptors are primarily based on the amount of elongation of muscle fibers around them in a muscle or muscle group. By putting external pressure on a designated point or designated points on the muscle or muscle group, there is an increase in the elongation of the muscle fibers, especially near a tendon.

While particular embodiments of the present exercise device are shown and described, it will be appreciated by those skilled in the art that changes and modifications may be made thereto without departing from the invention in its broader aspects and as set forth in the following claims.

What is claimed is:

1. An exercise device comprising:
a band;
a body attached to the band and having a plurality of sides and an upper surface and a bottom surface; and
a plurality of protruding members on one of said upper surface or said bottom surface, said plurality of protruding members being spaced from each other, wherein each of said protruding members has a semi-spherical shape and is positioned on a longitudinal axis of the body.

2. The exercise device of claim 1, wherein the body has a rectangular shape.

3. The exercise device of claim 1, wherein the protruding members each have a polygonal shape.

4. The exercise device of claim 1, wherein the body has one of a triangular shape or a circular shape.

5. The exercise device of claim 1, wherein the band includes an adjustment device that enables a length of the band to be adjusted.

6. The exercise device of claim 1, wherein the protruding members each have a different shape.

7. The exercise device of claim 1, wherein the protruding members are each a different size.

8. The exercise device of claim 1, wherein at least one of the protruding members is not on the longitudinal axis of the body.

9. The exercise device of claim 1, wherein the body includes opposing sides each having a slot and a rear surface with a recessed area, wherein the slots and the recessed area form a through channel configured to receive the band.

10. An exercise device comprising:
a harness having a primary band and two shoulder bands, where first ends of each of the two shoulder bands is attached to a front surface of the primary band and opposing second ends of the two shoulder bands is attached to a rear surface of the primary band;
at least one pocket attached to the primary band, wherein said at least one pocket includes an open top end; and
a pressure member including a body, wherein the body has a plurality of sides and an upper surface and a bottom surface, the pressure member being inserted into the open top end of said at least one pocket; and
a plurality of protruding members on one of said upper surface or said bottom surface of said body, said plurality of protruding members being spaced from each other, wherein each of said protruding members has a semi-spherical shape and is positioned on a longitudinal axis of the body.

11. The exercise device of claim 10, wherein the body has a rectangular shape.

12. The exercise device of claim 10, wherein the protruding members each have a polygonal shape.

13. The exercise device of claim 10, wherein the body has one of a triangular shape or a circular shape.

14. The exercise device of claim 10, wherein the band includes an adjustment device that enables a length of the band to be adjusted.

15. The exercise device of claim 10, wherein the protruding members each have a different shape.

16. The exercise device of claim 10, wherein the protruding members are each a different size.

17. The exercise device of claim 10, wherein at least one of the protruding members is not on the longitudinal axis of the body.

18. The exercise device of claim 10, wherein the body includes opposing sides each having a slot and a rear surface with a recessed area, wherein the slots and the recessed area form a through channel configured to receive the band.
